(19) United States
(12) Patent Application Publication
(10) Pub. No.: US 2005/0289134 A1
(43) Pub. Date: Dec. 29, 2005

(54) Apparatus, computer system, and data processing method for using ontology

(75) Inventor: Atsushi Noguchi, Yamato-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/153,085

(22) Filed: Jun. 15, 2005

(30) Foreign Application Priority Data
Jun. 24, 2004 (JP) 2004-186779

(51) Int. Cl. G06F 17/30

(52) U.S. Cl. 707/4

(57) ABSTRACT

Selecting and downloading a necessary part of an ontology from an ontology server in a semantic web technology. An ontology server according to the invention comprises an ontology storing section for storing a file of an ontology described in an ontology description language, and an ontology editing section for reading the ontology from the ontology storing section, extracting a given part from the read ontology, and transmitting it to an ontology client. The ontology server transmits a subset extracted from the ontology to the ontology client in response to a request from the ontology client.

### FIELD OF THE INVENTION

The present invention relates to a system and method for efficiently using an ontology in a semantic web technology.

### BACKGROUND

In recent years, semantic web technologies for enabling a computer to understand semantic contents and to perform various processes have been actively studied. Information retrieval systems using an ontology for semantic web technologies have been developed (for example, see Japanese Published Patent Application 2002-63033 and Japanese Published Patent Application 2001-92827). In this regard, the term “ontology” may be defined as “a specification of a conceptualization,” which is a knowledge notation for use in semantic descriptions on the semantic web. The ontology is implemented by, for example, a classification system and an inference rule book on a system.

FIG. 17 shows a diagram of an illustrative configuration of an information retrieval system based on the semantic web. In FIG. 17, a personal agent 1711 of an agent server 1710 generates an inquiry text described in an ontology description language such as OWL (Web Ontology Language) in response to a retrieval request made by a user, and transmits it to an agent server 1720. A broker agent 1721 of the agent server 1720 acquires information from the agent server providing web services on a network on the basis of the inquiry text received from the agent server 1710, generates a response text described in OWL on the basis of the acquired information, and sends the response text to the agent server 1710. The personal agent 1711 of the agent server 1710 returns the contents of the received response text to a user as a result of the retrieval.

In this regard, when the personal agent 1711 of the agent server 1710 generates the inquiry text and interprets the response text, and when the broker agent 1721 of the agent server 1720 interprets the inquiry text and generates the response text, the personal agent 1711 and the broker agent 1721 (hereinafter, they are collectively referred to as an agent) access an ontology server 1730 to reference the ontology.

FIG. 18 shows a situation where the agent references the ontology. In FIG. 18, the ontology server 1730 stores an ontology described in OWL. An agent 1810, which is a client of the ontology server 1730 (ontology client), downloads the entire ontology stored in the ontology server 1730, first, in order to generate and interpret the inquiry text and to generate and interpret the response text. At the time of generating the inquiry text or the response text, the agent 1810 describes IDs of words included in the text and describes URL of the ontology defining the words by referencing the downloaded ontology. On the other hand, when interpreting the inquiry text or the response text, the agent 1810 checks how concepts of the words in the text are defined in the downloaded ontology and executes retrieval and other processes on the basis of the acquired information.

As stated above, if an agent uses an ontology in a semantic web technology, conventionally the agent downloads and references the entire ontology stored in an ontology server. However, since a practical ontology covering general vocabulary has a large data size, there has been a problem in that downloading the entire ontology increases the load on the network or increases communication cost. Also, in processing with reference to the ontology, since the entire downloaded ontology needs to be referenced to acquire the desired vocabulary, it takes a long time to complete the processing.

### SUMMARY OF THE INVENTION

Therefore, it is an object of the present invention to provide a method and system for selecting and downloading a needed part of an ontology when an agent downloads the ontology from an ontology server in a semantic web technology. It is another object of the present invention to reduce the network load and communication cost when the agent uses the ontology and to reduce the time required for processing using the ontology.

In one embodiment, the present invention may be implemented as a computer system comprising an ontology server storing an ontology and an ontology client referencing the ontology by accessing the ontology server. In this system, the ontology server may include an ontology storing section storing data of the ontology described in an ontology description language and an ontology editing section for reading the ontology from the ontology storing section, extracting a given part from the readout ontology, and transmitting it to the ontology client.

In this embodiment, the ontology editing section in the ontology server receives a request with a specification of a target word and an ontology extraction condition from the ontology client and extracts from the ontology a part satisfying the target word and the extraction condition specified in the request, namely, a part of the ontology including the target word and words each having a given relation with the target word in the ontology definition. Preferably, the ontology editing section converts the ontology described in the ontology description language into N-triples notation and identifies a part to be extracted from the ontology by tracing relations between the words. Alternatively, the part to be extracted from the ontology may be identified by further converting the ontology in the N-triples notation to a resource description framework (RDF) model composed of nodes corresponding to the respective words and arcs indicating relations between the words, and then tracing the arcs between the nodes.

Preferably, regarding nodes corresponding to the words defined in the ontology, the ontology editing section may register and manage internode distance information indicating the number of arcs between individual nodes and other nodes in an internode distance table, and identify a part to be extracted from the ontology by referencing the internode distance information. Furthermore, the ontology editing section may register and manage a set of words to be treated as a group in a group node management table on the basis of the grammar of the ontology description language. At the time of ontology extraction, may identify a part to be extracted from the ontology without dividing the set of words registered in the group node management table.

The ontology client of the system may have an agent for transmitting a request specifying a given word and an ontology extraction condition to the server. The agent adds a parameter for specifying the given word and the ontology extraction condition to a URL of an ontology file and transmits an HTTP request including the URL having the description of the parameter to the ontology server.

In another embodiment, the present invention may be implemented as a data processing method of an ontology server transmitting an ontology to a client in response to a request from the client. This method comprises a step in which the ontology server reads data of the ontology described in an ontology description language from a storage device and explores relations between words defined in the ontology, a step in which the ontology server acquires a given word and an ontology extraction condition defined in the ontology and extracts a part satisfying the given word and the extraction condition from the ontology on the basis of relations between the words defined in the ontology, and a step in which the ontology server transmits the extracted part of the ontology to the client.

In still another embodiment, the present invention may be implemented as a program for controlling a computer to execute various functions of the foregoing ontology server, or a program for causing the computer to execute processes corresponding to the steps of the foregoing data processing method. The program may be distributed by a magnetic disk, an optical disk, a semiconductor memory, or other recording medium storing the program, or through a network.

The agent can select and download a necessary part of an ontology when downloading the ontology from the ontology server. Therefore, in a computer system using the ontology, it is possible to reduce the network load and communication cost, and to reduce the time required for processing using the ontology. Also, since the ontology client acquires and references only ontology information needed to perform its own processing, the time required for processing can be reduced.

### BRIEF DESCRIPTION OF THE DRAWINGS

FIG. 1 is a diagram showing a relation between an ontology server and an ontology client in a Semantic Web system.

FIG. 2 is a diagram showing an example of a hardware configuration of a computer system suitable to implement the ontology server and the ontology client.

FIGS. 3A and 3B are diagrams showing a data model in OWL for describing an ontology.

FIG. 4 is a diagram showing an example in which the OWL data model is represented by an RDF model.

FIG. 5 is a diagram showing data conversion at the time of extracting a part of the ontology.

FIG. 6 is a diagram showing an exemplary configuration of the ontology server.

FIG. 7 is a diagram showing a functional configuration of an RDF model management section.

FIG. 8 is a diagram showing an example of a data structure of the RDF model described in the C language.

FIG. 9 is a diagram showing an example of the RDF model.

FIG. 10 is a diagram representing the RDF model shown in FIG. 9 using the data structure shown in FIG. 8.

FIG. 11 is a diagram showing an illustrative configuration of an internode distance table.

FIG. 12 is a diagram showing an illustrative configuration of a group node management table.

FIG. 13 is a diagram showing an example of an ontology extraction range identified by specifying a node and the number of layers.

FIG. 14 is a diagram showing an example of an ontology extraction range identified by specifying a node and the number of nodes.

FIG. 15 is a diagram showing an example of an ontology extraction range identified by specifying a plurality of nodes and the number of layers from nodes on the shortest path between the nodes.

FIG. 16 is a flowchart for explaining an operation of the ontology server in the embodiment.

FIG. 17 is a diagram showing an illustrative configuration of an information retrieval system using a semantic web technology.

FIG. 18 is a diagram showing a situation where an agent references the ontology.

### DETAILED DESCRIPTION

Preferred embodiments of the present invention will now be described in detail hereinafter with reference to the accompanying drawings. The description starts with an outline of the embodiment.

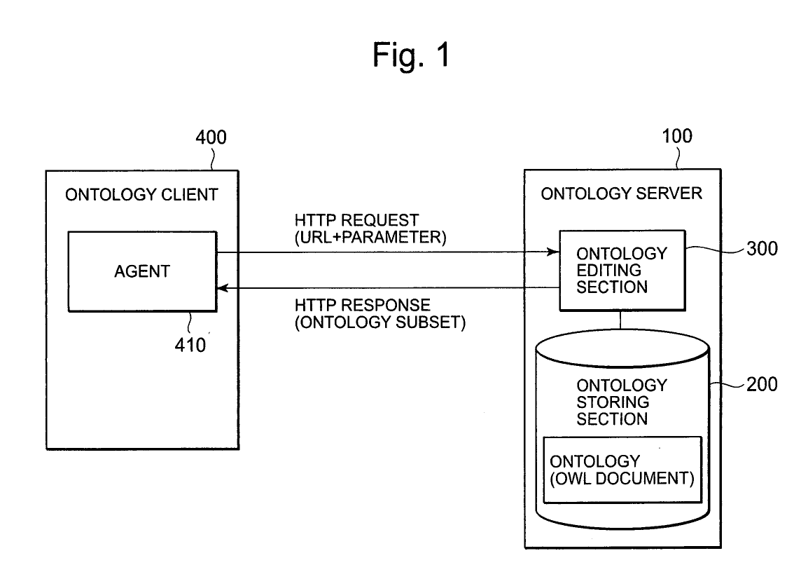

FIG. 1 shows a relation between an ontology server and an ontology client in a semantic web system. As shown in FIG. 1, the ontology server 100 of this embodiment comprises an ontology storing section 100 storing an ontology, which is an OWL document, and an ontology editing section 300 for extracting a part of the ontology stored in the ontology storing section 200 in response to a request from an ontology client 400, and returning it thereto. The ontology client 400 may correspond to a client machine used by a user, a portal server, an agent server for a search site, or any other information processing device which accesses the ontology server 100 to use the ontology, and may include an agent 410 for accessing the ontology server 100.

In the system shown in FIG. 1, the agent 410 of the ontology client 400 generates an HTTP request including a URL of the ontology and a parameter (URL parameter) stored in the ontology storing section 200 of the ontology server 100 and transmits it to the ontology server 100. The parameter included in the HTTP request will be described later.

In the ontology server 100 that receives the HTTP request, the ontology editing section 300 interprets the HTTP request, extracts a part of the ontology stored in the ontology storing section 200 on the basis of the parameter, and returns the extracted subset of the ontology as an HTTP response to the ontology client 400.

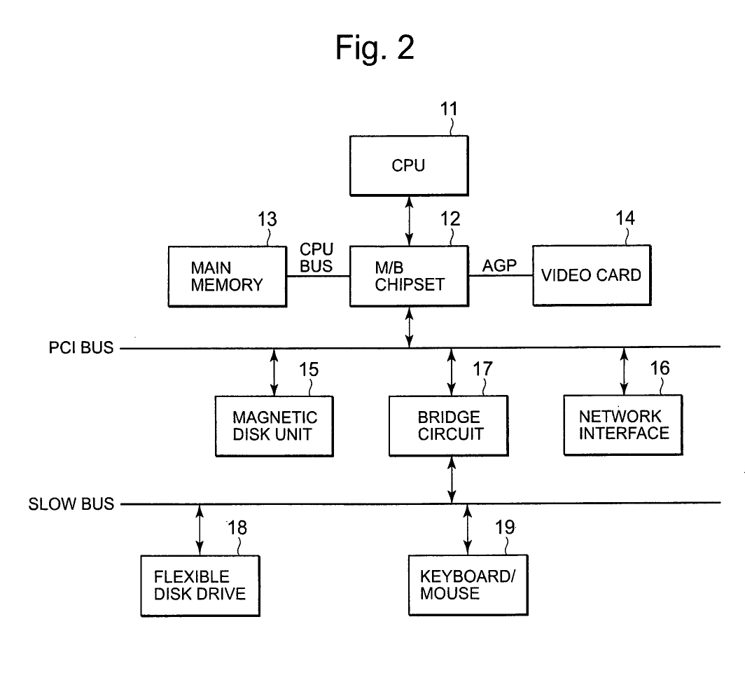

FIG. 2 shows a diagram illustrating an example of a hardware configuration of a computer system suitable for implementing the ontology server 100 and the ontology client 400. The computer system shown in FIG. 2 comprises a central processing unit (CPU) 11 as computation means, a main memory 13 connected to the CPU 11 via a motherboard (M/B) chipset 12 and a CPU bus, a video card 14 similarly connected to the CPU 11 via the M/B chipset 12 and an AGP (Accelerated Graphics Port), a magnetic disk unit (HDD) 15 connected to the M/B chipset 12 via a PCI (Peripheral Component Interconnect) bus, a network interface 16, and a flexible disk drive 18 and a keyboard/mouse 19 connected to the M/B chipset 12 from the PCI bus via a bridge circuit 17 and a slow bus such as an ISA (Industry Standard Architecture) bus.

Note that FIG. 2 illustrates an exemplary hardware configuration of a computer system suitable for implementing the invention, and that other suitable configurations may be used as well. For example, the configuration may be one in which only a video memory is mounted instead of providing the video card 14 and the CPU 11 processes image data. Also, as an external storage, a CD-R (Compact Disc Recordable) or DVD-RAM (Digital Versatile Disc Random Access Memory) drive may be provided via an interface such as ATA (AT Attachment) or SCSI (Small Computer System Interface).

Next, the ontology server 100 according to this embodiment will be described in detail below. As stated above, the ontology server 100 of this embodiment extracts a part of the ontology stored in the ontology storing section 200 according to the extraction condition specified by the parameter included in the HTTP request from the ontology client 400 and generates a subset of the ontology. The ontology extraction work will be described first.

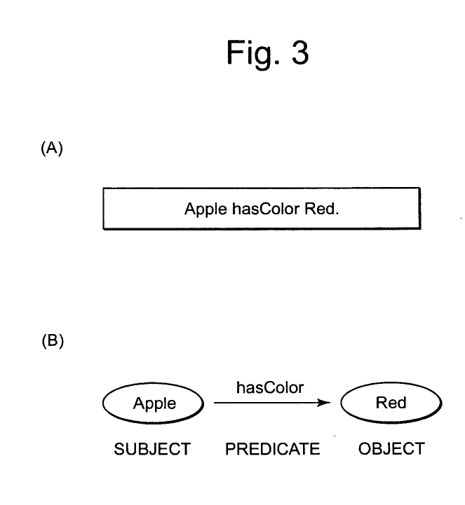

FIG. 3 shows a diagram of an OWL data model for describing the ontology. The OWL is described on the basis of RDF (Resource Description Framework). The RDF describes a data model in which a chain of relations can be traced by means of a tripartite relationship between a subject (resource), a predicate (property), and an object (property value). The RDF data model can be represented by a notation referred to as N-triple which describes a subject, a predicate, and an object in a single line as shown in FIG. 3(A), or by a labeled, directed graph as shown in FIG. 3(B). Therefore, an ontology described in OWL can be represented by an RDF model (graph model) in which the words defined in the ontology are used as nodes and relations between the words are used as arcs between the nodes. In this case, the nodes correspond to a subject and an object in the N-triples notation and the arc between the nodes corresponds to a predicate.

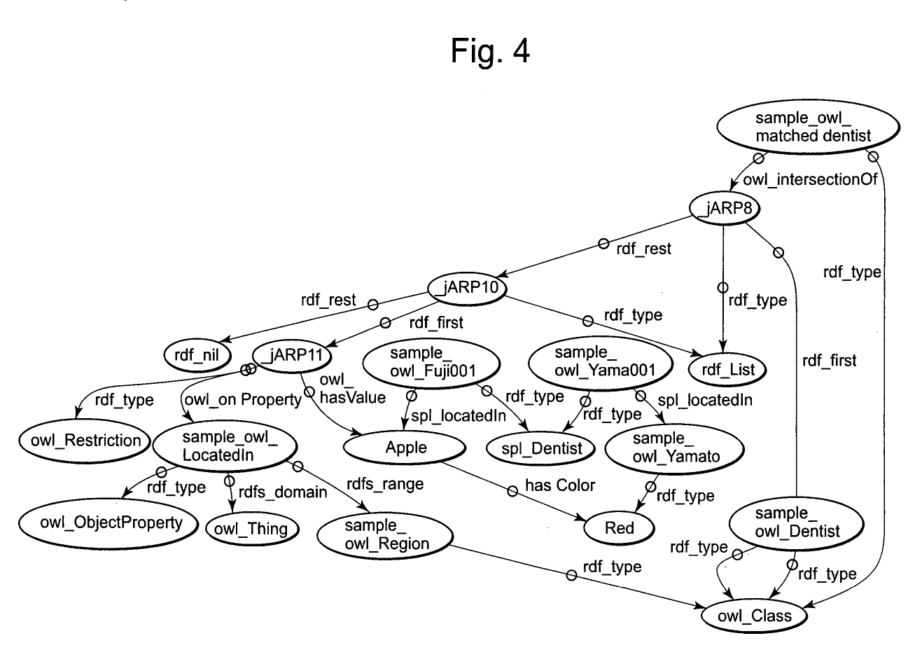

FIG. 4 illustrates an example in which the OWL data model is represented by the RDF model. In FIG. 4, any two nodes connected by an arc are in a relation between a subject and an object with the arc therebetween being a predicate. In this embodiment, the ontology editing section 300 generates a subset of the ontology by extracting a part of the ontology therefrom. In this regard, the ontology editing section 300 needs to know the relations between the words defined in the ontology to identify the part to be extracted. Therefore, in this embodiment, as a measure for the ontology editing section 300 to learn the relations between the words defined in the ontology, the ontology described in OWL and stored in the ontology storing section 200 is converted into the N-triples notation.

It is more efficient to target the RDF model than to target the ontology in the N-triples notation when identifying a part to be extracted from the ontology, namely, a part satisfying the extraction condition specified by the parameter included in the HTTP request from the ontology client 400, for the following reasons. If the ontology in the N-triples notation is a target of identifying the part satisfying the extraction condition, there is a need for retrieving words satisfying the extraction condition one by one while scanning the entire description in the N-triples notation repeatedly. On the other hand, if the RDF model is a target, it is only necessary to identify nodes satisfying the extraction condition sequentially while tracing the arcs. Therefore, in this embodiment, the ontology editing section 300 generates an RDF model equivalent to an ontology described in the N-triples notation therefrom, identifies a part to be extracted on the RDF model, and generates a subset.

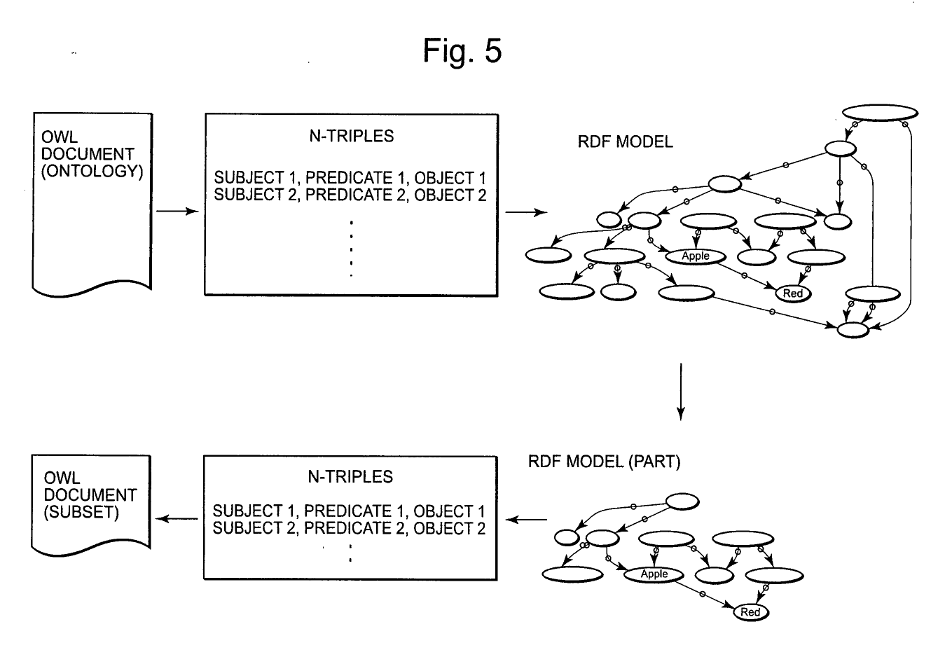

FIG. 5 shows a situation of a data conversion at the time of the ontology extraction. As stated above, the ontology as the OWL document read from the ontology storing section 200 is converted into the N-triples notation and then converted to an RDF model. Thereafter, a part of the RDF model is extracted. Subsequently, the extracted part of the RDF model is converted into the N-triples notation and then converted into an OWL document to generate a subset of the ontology satisfying the extraction condition. Accordingly, in this embodiment, when the ontology client 400 transmits an HTTP request for requesting acquisition of the ontology to the ontology server 100, the ontology server 100 transmits an HTTP response including the subset of the ontology to the ontology client 400.

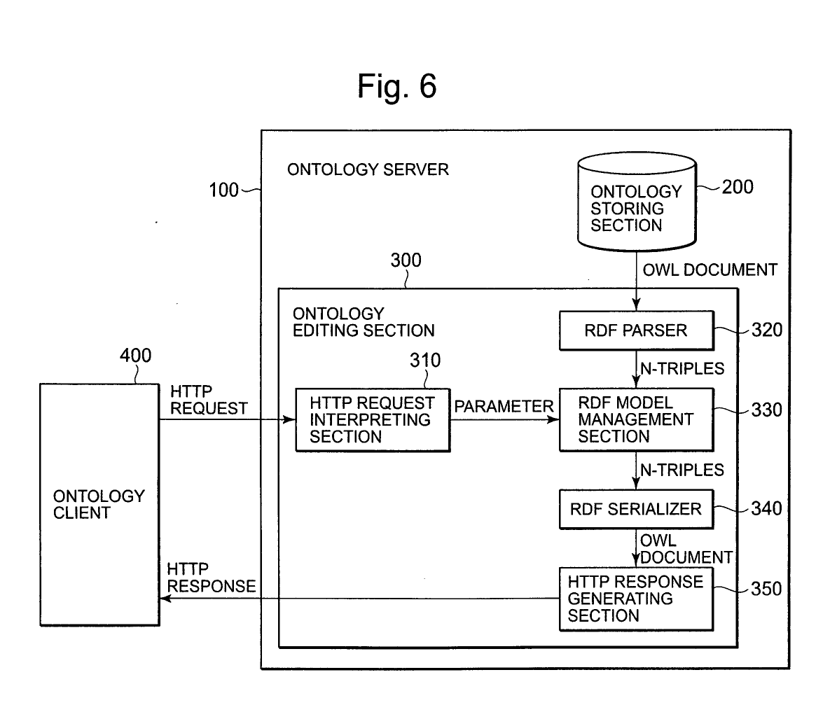

FIG. 6 shows an exemplary configuration of the ontology server 100. In FIG. 6, the ontology storing section 200 is implemented by storage means such as the main memory 13 or the magnetic disk unit 15 in FIG. 2. The ontology storing section 200 stores an OWL document described as an RDF/XML document (RDF document in the XML notation).

The ontology editing section 300 may be implemented by, for example, the program-controlled CPU 11 and main memory 13 or other storage means of the computer system shown in FIG. 2. As shown in FIG. 6, the ontology editing section 300 includes an HTTP request interpreting section 310 for interpreting an HTTP request received from the ontology client 400, an RDF parser 320 for extracting a part of the ontology, an RDF model management section 330, an RDF serializer 340, and an HTTP response generating section 350.

The HTTP request interpreting section 310 interprets an HTTP request transmitted from the ontology client 400 and extracts a parameter describing the extraction condition of the ontology included in the HTTP request. The RDF parser 320 reads the OWL document of the ontology from the ontology storing section 200 and converts it into the N-triples notation.

The RDF model management section 330 receives the parameter extracted by the HTTP request interpreting section 310 and the ontology in the N-triples notation converted by the RDF parser 320, and extracts a part of the ontology on the basis of the extraction condition specified by the parameter. The extracted subset of the ontology is described in the N-triples notation. Details of the ontology extraction processing will be described later.

The RDF serializer 340 converts the subset of the ontology extracted by the RDF model management section 330 to an OWL document (RDF/XML document).

The HTTP response generating section 350 generates an HTTP response including the subset of the ontology in the form of the OWL document generated by the RDF serializer 340 and returns it to the ontology client 400 that has transmitted the HTTP request.

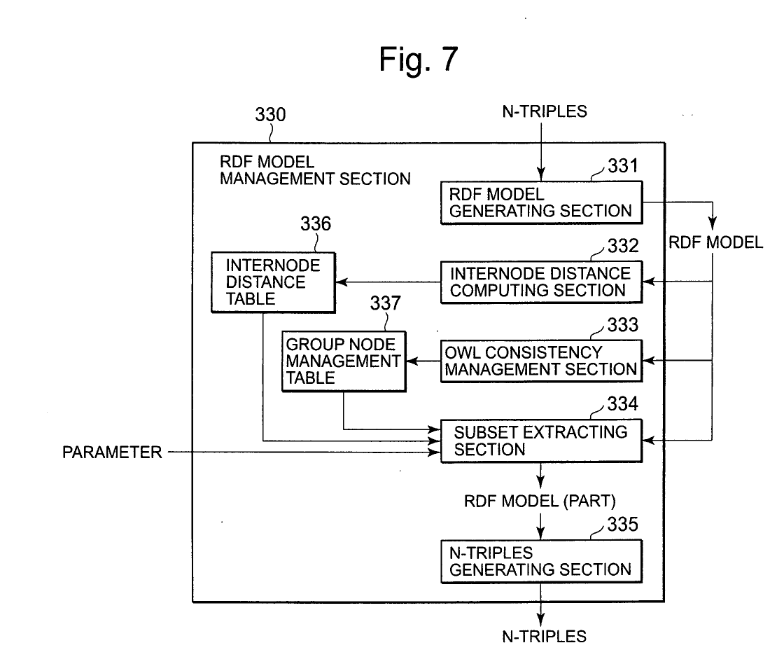

FIG. 7 shows a functional configuration of the RDF model management section 330. Referring to FIG. 7, the RDF model management section 330 includes an RDF model generating section 331, an internode distance computing section 332, an OWL consistency management section 333, a subset extracting section 334, and an N-triples generating section 335.

The RDF model generating section 331 generates an RDF model as shown in FIG. 4 from the ontology in the N-triples notation input from the RDF parser 320. The generated RDF model may be stored in, for example, the main memory or a cache memory of the CPU 11 shown in FIG. 2.

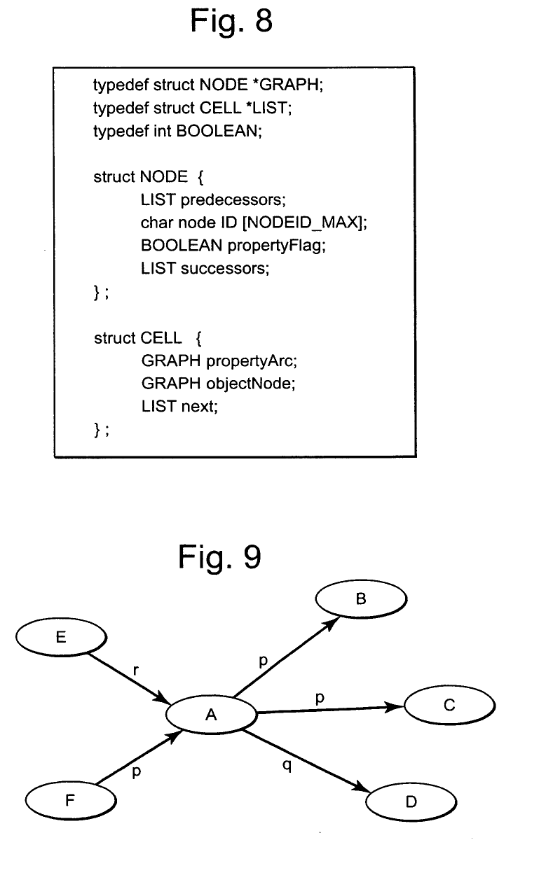

FIG. 8 shows an example of a data structure in which an RDF model is described in the C language. In this regard, an RDF model shown in FIG. 9 is discussed below. In FIG. 9, a node A is an object of a node E due to a relation indicated by an arc r corresponding to a predicate. Similarly, it is an object of a node F due to a relation indicated by an arc p. On the other hand, the node A is a subject of a node B and a node C due to a relation indicated by an arc p. Also, it is a subject of a node D due to a relation indicated by an arc q.

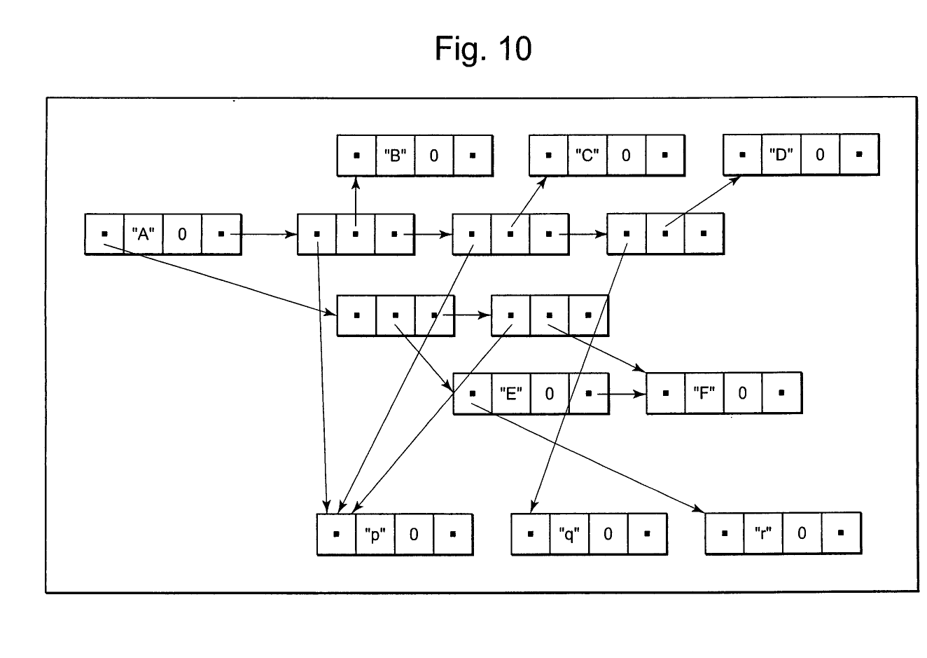

FIG. 10 shows a diagram which represents the RDF model in FIG. 9 by using the data structure shown in FIG. 8. In FIG. 10, each data block representing a node or an arc is associated with another data block by describing therein a pointer to that data block, so that the representation corresponds to the image of the RDF model shown in FIG. 9.

The internode distance computing section 332 computes, for each node of the RDF model generated by the RDF model generating section 331, a distance between that node and each of the other nodes, and registers the distances in an internode distance table 336.

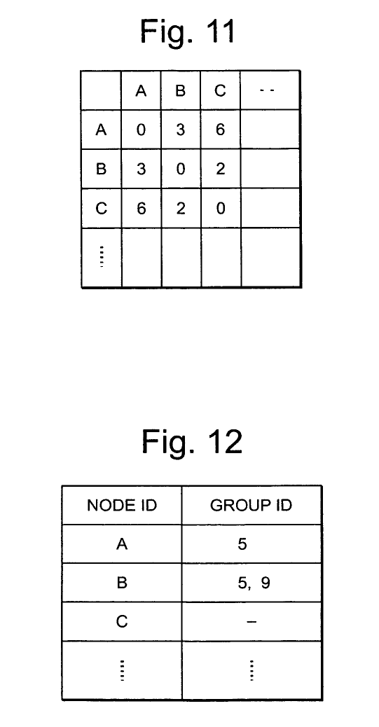

FIG. 11 shows an example of the internode distance table 336. The internode distance table 336 shown in FIG. 11 is a two-dimensional table with node IDs being arranged as entry items, in which internode distance values are registered for all combinations of two nodes. For example, in FIG. 11, a distance between the nodes A and B is three, and a distance between the nodes A and C is six. In this regard, the internode distance value is the number of arcs passed through from one node to another on the RDF model. Alternatively, pointers to corresponding nodes on the RDF model may be registered in the table. The generated internode distance table 336 may be stored in, for example, the main memory 13 or the cache memory of the CPU 11 shown in FIG. 2.

The OWL consistency management section 333 identifies a set of nodes to be treated as a single group among the nodes of the RDF model generated by the RDF model generating section 331, and registers it in a group node management table 337. In the case of OWL language elements, an inconsistency may occur in terms of the OWL grammar unless a plurality of predetermined nodes are treated as a set. Therefore, such a node set is managed as a group so as to prevent the node set from being divided at the time of extracting a part of the ontology.

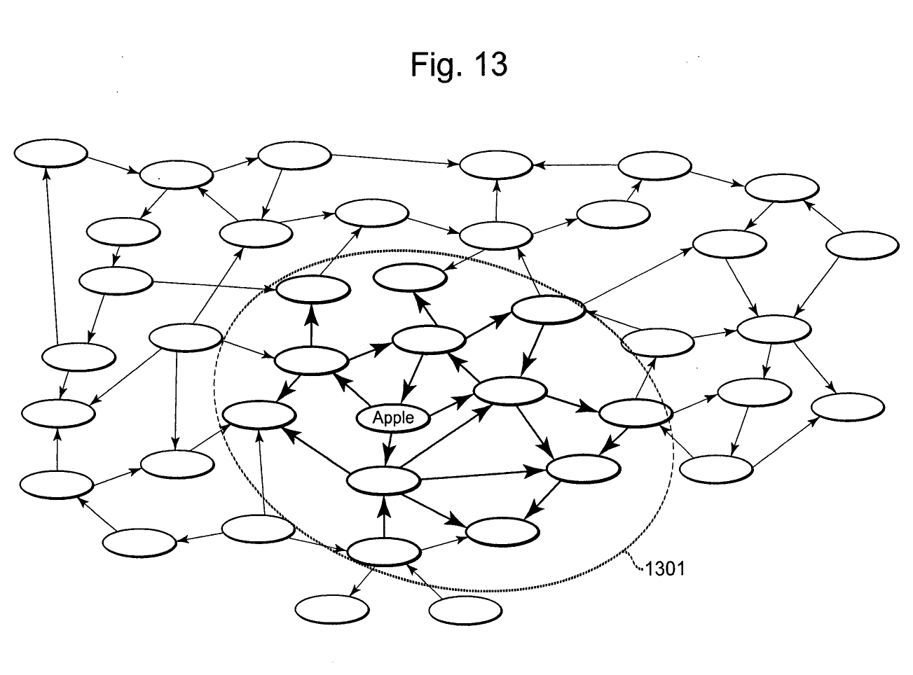

FIG. 12 shows an example of the group node management table 337. In the group node management table 337 shown in FIG. 12, IDs of the nodes are registered in association with IDs of the groups corresponding to the respective nodes. One node may belong to a plurality of groups, such as the node B shown in FIG. 12. The generated group node management table 337 may be stored in, for example, the main memory 13 or the cache memory of the CPU 11 shown in FIG. 2.

An example of a node set to be treated as a group is a combination of one of the following properties and, for example, owl:onProperty:

owl:hasValue

owl:allValuesFrom

owl:someValuesFrom

owl:cardinality

owl:maxCardinality

owl:minCardinality

More specifically, three nodes A, B, and C are treated as a group if a property of an arc between the nodes A and B is owl:onProperty with the node A being a subject and the node B being an object, and if a property of an arc between the nodes A and C is one of the above six properties with the node A being a subject and the node C being an object (the RDF model is not divided at the arc between the nodes A and B and at the arc between the nodes A and C). Also, nodes corresponding to OWL language elements using a combination of rdf:first and rdf:rest in the RDF are treated as a group.

A relation which does not divide the RDF model preferably may be appropriately set on the basis of the OWL grammar. When the OWL grammar is updated, the relation setting may also be updated dynamically.

The subset extracting section 334 receives the parameter extracted from the HTTP request by the HTTP request interpreting section 310, extracts a part satisfying the extraction condition specified by the parameter from the RDF model generated by the RDF model generating section 331, and generates a subset of the RDF model. At that time, it is possible to reference the internode distance table 336 and the group node management table 337. When the part of the RDF model is extracted, it is possible to identify a part satisfying the extraction condition by tracing the nodes and arcs of the RDF model, but the part satisfying the extraction condition can be efficiently identified by referencing the internode distance table 336 depending on a method of specifying the extraction condition described later. As described above, the node set of the group registered in the group node management table 337 is not divided when the part of the RDF model is extracted.

When the part of the RDF model is extracted, properties each forming an arc between the nodes are extracted from the original RDF model. The property can be rdf:type of owl:Property since propertyFlag of the RDF model is set to 1. The subset of the RDF model generated by the subset extracting section 334 as described above may be stored in, for example, the main memory 13 or the cache memory of the CPU 11 shown in FIG. 2.

The N-triples generating section 335 generates an ontology in the N-triples notation corresponding to the subset of the RDF model generated by the subset extracting section 334 therefrom. The generated ontology in the N-triples notation may be stored in, for example, the main memory 13 or the cache memory of the CPU 11 shown in FIG. 2, and read into and processed by the RDF serializer 340.

The method of specifying the extraction condition for the ontology for generating the subset of the ontology will next be described.

A target node (word) for acquiring the ontology information and a range of required information are specified as an extraction condition in order to appropriately extract the subset requested by the agent 410 of the ontology client 400. As for a method of specifying the information range, there can be, for example, a method of specifying the number of layers (distance) from the target node, or a method of specifying the number of nodes included in the subset. The extraction condition is added to a URL of the ontology as a part of the URL (URL parameter) in an HTTP request made by the agent 410 for downloading the ontology from the ontology server 100.

Next, some examples of the method of specifying the extraction condition and the description in its parameter in this embodiment will be described.

Specification method with a target node and the number of layers:

This specification method is carried out by specifying a target node and the number of layers from the target node so as to extract a subset ranging from the target node to a node reached by tracing arcs by the specified number of layers from the target node.

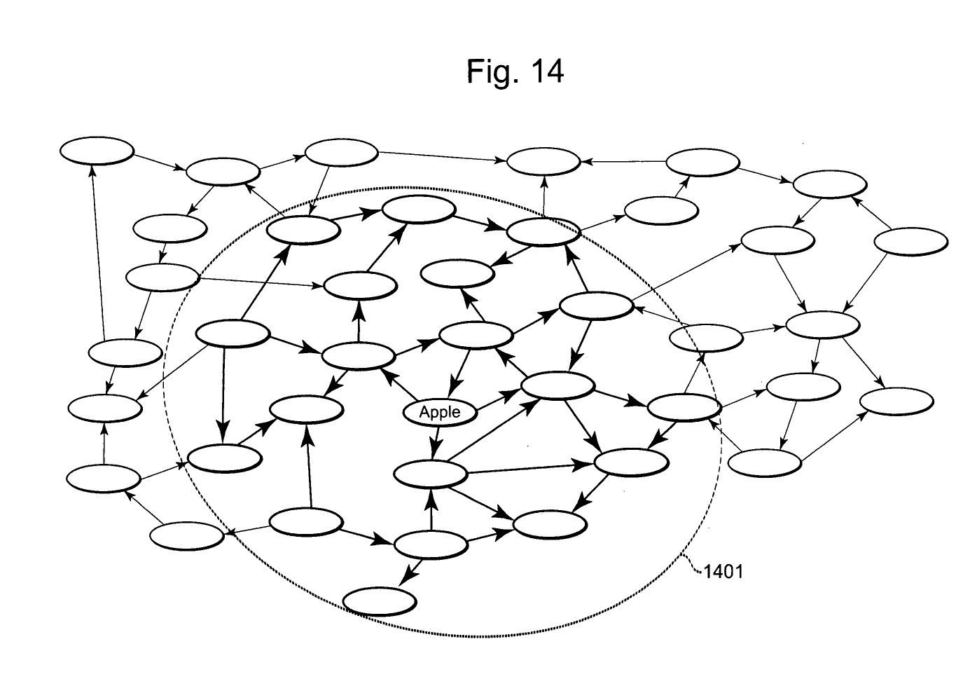

FIG. 13 shows an example of the extracted range of the ontology identified by specifying the node and the number of layers. In the example shown in FIG. 13, the extraction condition is specified by the description, http://www.ibm.com/ontology/upperlevel.owl?id1=Apple&layer1=2. In this URL, the description up to “--.owl” is a URL of the OWL document of the ontology and the “?id1=Apple&layer1=2” part is a parameter describing the extraction condition. In this parameter description, the target node and the number of layers are specified as “Apple” and “2” in the extraction condition, respectively. In FIG. 13, a range 1301 enclosed by a dotted line satisfies the extraction condition and the range is a part of the ontology to be extracted as a subset. Referring to FIG. 13, the range 1301 enclosed by the dotted line ranges from the node “Apple” to nodes reached by tracing two arcs (these nodes and arcs are indicated by thick lines in FIG. 13).

More generally, this specification method can specify a plurality of nodes. For example, by the description, “http://www.ibm.com/ontology/upperlevel.owl?idl=Apple&layer1=2&id2=Monkey&la yer2=3”, the extraction condition is specified as follows:

Node=“Apple”; the number of layers=2

Node=“Monkey”; the number of layers=3

With this extraction condition, nodes ranging from the node “Apple” up to nodes reached by tracing two arcs and nodes ranging from the node “Monkey” up to nodes reached by tracing three arcs are identified as a part to be extracted as a subset.

In the above, it is possible to predetermine a default value for the number of layers and to apply it unless the number of layers is specified in the parameter. For example, in the description “http://www.ibm.com/ontology/upperlevel.owl?id1=Apple&id2=Monkey&defaultLay er=2”, the nodes “Apple” and “Monkey” are specified, but the number of layers for each of these nodes is not specified. In this case, 2 is applied as the default value for the number of layers (defaultLayer) and therefore a range from each of the nodes “Apple” and “Monkey” to nodes reached by tracing two arcs is a part to be extracted as a subset.

Similarly, in the description “http://www.ibm.com/ontology/upperlevel.owl?id1=Apple&layer1=2&id2=Monkey&d efaultLayer=3”, 2 is specified as the number of layers for the node “Apple”, but the number of layers is not specified for the node “Monkey” and therefore 3 is applied as the default value for the number of layers.

Specification method with a target node and the number of nodes:

This specification method is carried out by specifying a target node and the number of nodes included in a subset so as to identify nodes sequentially from a node nearest the target node and extracting a subset up to the specified number of nodes when the number of identified nodes reaches the specified number of nodes. As the way to specify the number of nodes, for example, it is possible to specify a percentage of the number of nodes of the entire ontology.

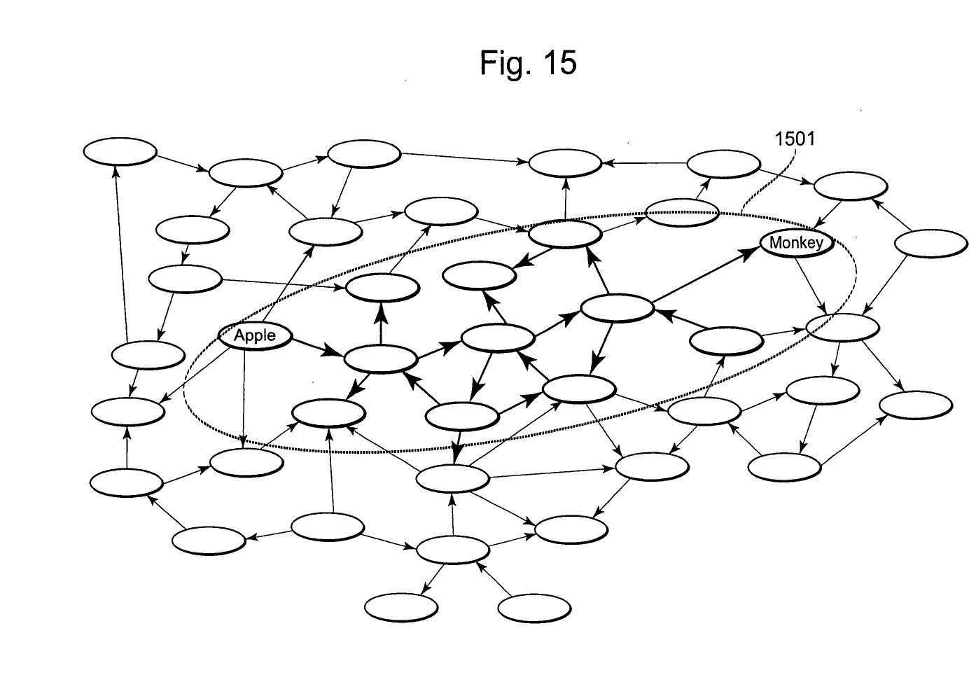

FIG. 14 shows an example of the extraction range of the ontology identified by specifying a target node and the number of nodes. In the example shown in FIG. 14, the extraction condition is specified by the description, “http://www.ibm.com/ontology/upperlevel.owl?id1=Apple&rate1=50.” In this URL, the description up to “--.owl” is a URL of the OWL document of the ontology and the “?id1=Apple&rate1=50” part is a parameter describing the extraction condition. In this parameter description, “Apple” and 50% of the number of nodes of the entire ontology are specified as the target node and the number of nodes in the extraction condition, respectively. In FIG. 14, a range 1401 enclosed by a dotted line satisfies the extraction condition and this range is a part of the ontology to be extracted as a subset. Referring to FIG. 14, 50% (=20) nodes of the entire ontology are included in the range 1401 enclosed by the dotted line around the node “Apple” (these nodes and arcs are indicated by thick lines in FIG. 14). The range 1401 include all nodes reached by tracing two arcs from the node “Apple” and some of nodes reached by tracing three arcs from the node “Apple”.

More generally, this specification method can specify a plurality of nodes. For example, by the description “http://www.ibm.com/ontology/upperlevel.owl?idl=Apple&rate1=10&id2=Monkey&r ate2=20”, the following extraction condition is specified:

Node=“Apple”; the number of layers=10% of the entire ontology

Node=“Monkey”; the number of layers=20% of the entire ontology

With this extraction condition, 10% nodes of the entire ontology around the node “Apple” and 20% nodes of the entire ontology around the node “Monkey” are identified as a part to be extracted as a subset.

In the above, it is possible to predetermine a default value for the number of nodes and to apply it unless the number of nodes is specified in the parameter.

For example, in the description “http://www.ibm.com/ontology/upperlevel.owl?id1=Apple&id2=Monkey&defaultRat e=10”, the nodes “Apple” and “Monkey” are specified, but the number of nodes for each of these nodes is not specified. In this case, 10% is applied as the default value for the number of nodes (defaultRate) and therefore 10% nodes of the entire ontology are identified around the nodes “Apple” and “Monkey” as a part to be extracted as a subset.

Similarly, in the description “http://www.ibm.com/ontology/upperlevel.owl?id1=Apple&rate1=10&id2=Monkey& defaultRate=20”, 10% is specified as the number of nodes for the node “Apple,” but the number of nodes is not specified for the node “Monkey” and therefore 20% is applied as the default value for the number of nodes.

Alternatively, it is possible to specify a numeric value as the number of nodes to be included in the subset directly instead of specifying a percentage of the number of nodes in the entire ontology. However, in view of the fact that a practical ontology server stores an enormous number of nodes of the ontology and that the relations between nodes are unknown until the server actually explores the ontology, it would be appropriate to use the method of specifying the number of nodes by means of the percentage to the number of nodes of the entire ontology.

Specification method with a plurality of nodes and the number of layers from nodes on the shortest path between the nodes:

This specification method is carried out by specifying a plurality of target nodes and specifying the number of layers from nodes on the shortest path between the target nodes so as to extract a subset ranging from the nodes to nodes reached by tracing arcs by the specified number of layers from the nodes.

FIG. 15 shows an example of the extraction range of the ontology identified by specifying a plurality of target nodes and the number of layers from nodes on the shortest path between the target nodes. In the example shown in FIG. 15, the extraction condition is specified by the description “http://www.ibm.com/ontology/upperlevel.owl?id1=Apple&id2=Monkey&dijkstraLay er=1.” In this URL, the description up to “--.owl” is a URL of the OWL document of the ontology and the “?id1=Apple&id2=Monkey&dijkstraLayer=1” part is a parameter describing the extraction condition. In this parameter description, the target nodes are specified as “Apple” and “Monkey” and the number of layers (dijkstraLayer) from the nodes on the shortest path between the target nodes is specified as “1” in the extraction condition. In FIG. 15, a range 1501 enclosed by a dotted line satisfies the extraction condition and the range is a part to be extracted as a subset. Referring to FIG. 15, the range 1501 enclosed by the dotted line ranges up to nodes reached by tracing one arc from each node (each of nodes A, B, and C indicated by thick lines in FIG. 15) on the shortest path between the nodes “Apple” and “Monkey” (these nodes and arcs are indicated by thick lines in FIG. 15).

This specification method can specify a plurality of sets of target nodes for identifying paths and to specify the number of layers from nodes on the shortest paths. For example, by the description “http://www.ibm.com/ontology/upperlevel.owl?idl1=Apple&id 12=Monkey&dijkstraLa yer1=5&id21=Apple&id22=Dog&dijkstraLayer2=3”, the extraction condition is specified as follows:

Nodes=“Apple” and “Monkey”; the number of layers from the nodes on the shortest path=5

Nodes=“Apple” and “Dog”; the number of layers from the nodes on the shortest path=3

With this extraction condition, the range up to nodes reached by tracing five arcs from each node on the shortest path between the nodes “Apple” and “Monkey” and the range up to nodes reached by tracing three arcs from each node on the shortest path between the nodes “Apple” and “Dog” are identified as a part to be extracted as a subset.

When the nodes included in the subset have been identified as stated above, the subset extracting section 334 collates these nodes with the group node management table 337. If the nodes have already been registered, all other nodes in the group to which the identified nodes belong are identified as nodes included in the subset.

It is also possible to describe the parameter by mixing a plurality of extraction condition specification methods described above. In that case, the range represented by a sum of extracted ranges identified by the respective specification methods is a part to be extracted as a subset.

In the foregoing extraction condition specification methods 1 and 3, the number of layers from the target node is specified in the parameter of the HTTP request and the nodes reached by tracing arcs from the target node determine the range of the subset. In this case, the nodes included in the subset can be identified by tracing the arcs from the target node in the RDF model. However, if the internode distance table 336 is prepared, the subset range can be determined more efficiently by using it. Specifically, the subset extracting section 334 detects nodes with their distances from the target node being equal to or smaller than the number of layers specified in the parameter by referencing the internode distance table 336, and then determines a range of the subset by identifying the detected nodes on the RDF model.

Similarly, also in the foregoing extraction condition specification method 2, the subset range can be determined efficiently by using the internode distance table 336. Specifically, the subset extracting section 334 first detects nodes having 1 as a value of the distance from the target node by referencing the internode distance table 336 and continues to detect nodes sequentially in ascending order of the value of the distance from the target node while determining whether the number of the detected nodes has reached the number of nodes specified in the parameter of the HTTP request. In the example shown in FIG. 14, all the nodes reached by tracing two arcs from the node “Apple” are included in the subset. Therefore, nodes having 2 or less as the value of the distance from the node “Apple” in the internode distance table 336 can be directly identified as nodes included in the subset. However, since the total number of nodes having 3 or less as the value of the distance from the node “Apple” exceeds the number of nodes specified by the parameter, the subset extracting section 334 makes a choice among the nodes having 3 as the value of the distance from the node “Apple” by referencing the RDF model or the internode distance table 336 and identifies nodes one by one until the number of identified nodes becomes equal to the one specified in the parameter.

Next, a flow of the entire operation of the ontology server 100 will be described.

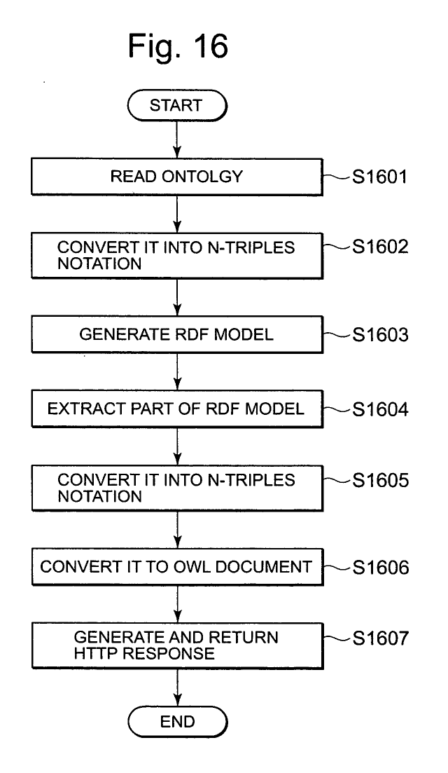

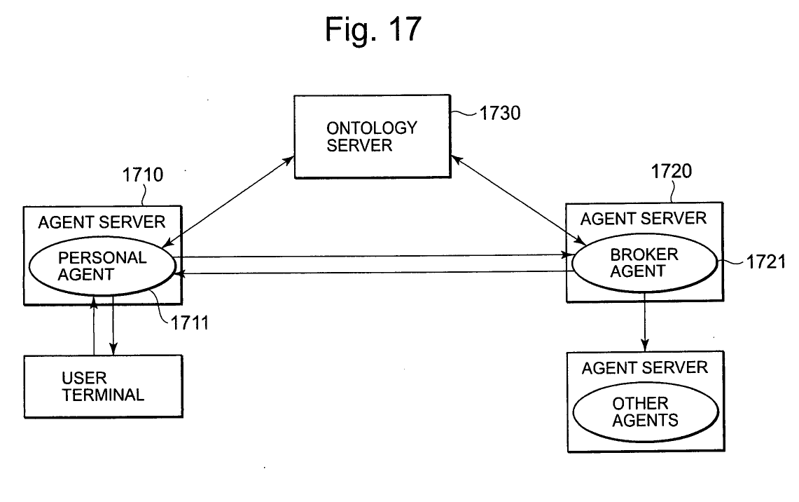

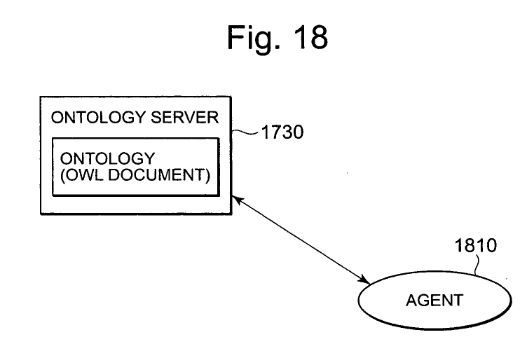

FIG. 16 shows a flowchart for explaining the operation of the ontology server 100. As shown in FIG. 16, the ontology editing section 300 of the ontology server 100 reads the ontology from the ontology storing section 200 (step 1601), and parses the read ontology and converts it into the N-triples notation (step 1602). It then generates an RDF model from the ontology in the N-triples notation (step 1603). At the same time, the internode distance table 336 and the group node management table 337 are also generated.

The operation so far can be performed without the ontology extraction condition. Therefore, it may be performed in advance as a preparatory operation before receiving an HTTP request from the ontology client 400.

Responsive to receiving the HTTP request requesting acquisition of the ontology from the ontology client 400, the ontology editing section 300 extracts a part of the RDF model generated in the step 1603 on the basis of the extraction condition described in the parameter of the received HTTP request (step 1604). It then converts the extracted part into the N-triples notation (step 1605) and further converts it to an OWL document after serialization (step 1606). Finally, the ontology editing section 300 generates an HTTP response containing the subset of the ontology converted to the OWL document, and returns it to the ontology client 400 that has transmitted the HTTP request (step 1607).

As stated above, the ontology server 100 of this embodiment provides only a part of an ontology corresponding to information required by the ontology client 400 instead of the entire ontology, in response to a request for acquiring the ontology from the ontology client 400. This reduces the load on the network and communication cost. Also, since the ontology client 400 acquires and references only ontology information necessary for performing its own processing, the processing time can be reduced.

On the other hand, since the ontology server 100 converts an OWL document to an RDF model in this embodiment, and extracts a part thereof and converts the extracted part to an OWL document again to generate a subset of the ontology, the ontology server 100 needs to perform more processing in comparison with a case where it transmits the entire ontology to the ontology client 400. Accordingly, the ontology client 400 needs longer time for downloading the ontology.

As described above, if the ontology server 100 converts in advance the ontology in the OWL document to the RDF model before receiving the HTTP request from the ontology client 400, it is possible to minimize the increase in time for the ontology client 400 to download the ontology. In this case, however, when the ontology in the OWL document is updated, there is a need for converting it to an RDF model and for generating the internode distance table 336 and the group node management table 337 to keep them up to date at all times. There is no requirement, of course, to convert the OWL document to the RDF model in advance. If the ontology server 100 is of high performance and can perform the conversion processing at a higher speed, the OWL document could be read and the data format could be converted after receiving the HTTP request.

Also, in this embodiment, after the ontology of the OWL document is converted to an RDF model, a part satisfying a given extraction condition is extracted. As described above, however, the OWL document is converted to the RDF model in order to inform the ontology editing section 300 of relations between words defined in the ontology and for the reason that the operation of identifying a part satisfying the extraction condition from the graph of the RDF model is simpler than retrieving the part from the OWL document or the N-triples notation. Therefore, it is possible to retrieve words satisfying the extraction condition derived from the HTTP request and its definition directly from the OWL document or to retrieve them from the ontology in the N-triples notation on the basis of the extraction condition.

If a subset is generated directly from the OWL document, the RDF parser 320 and the RDF serializer 340 would not be needed in the configuration of the ontology editing section 300 of the ontology server 100 shown in FIG. 6. The RDF model management section 330 scans the OWL document and retrieves a definition of a word satisfying the extraction condition. Also, if the part is extracted from the ontology in the N-triples notation, the RDF model generating section 331 and the N-triples generating section 335 would not be needed in the configuration of the RDF model management section 330 of the ontology server 100 shown in FIG. 7. The subset extracting section 334 scans the ontology in the N-triples notation and retrieves a word satisfying the extraction condition.

1. An apparatus for processing a request from a client referencing an ontology, comprising:
an ontology storing section for storing data of an ontology described in an ontology description language; and
an ontology editing section for reading the ontology from the ontology storing section, extracting a part required for reference by a client from the read ontology, and transmitting the part of the ontology to the client.

2. An apparatus according to claim 1, wherein the ontology editing section extracts at least one target word included in a request from the client and at least one word satisfying a given condition relative to the target word in the ontology.

3. An apparatus according to claim 2, wherein words included in the ontology are represented by nodes, and wherein the given condition is specified by a node corresponding to the target word and by the number of layers from the target node.

4. An apparatus according to claim 3, wherein the given condition is specified by the number of layers from nodes on a shortest path between a plurality of nodes if a plurality of target words are specified.

5. An apparatus according to claim 2, wherein words included in the ontology are represented by nodes, and wherein the given condition is specified by a node corresponding to the target word and the number of extracted nodes.

6. An apparatus according to claim 1, wherein the ontology editing section converts the ontology described in the ontology description language into an N-triples notation and identifies a part to be extracted from the ontology by tracing relations between the words.

7. An apparatus according to claim 1, wherein the ontology editing section converts the ontology described in the ontology description language to an RDF model having nodes corresponding to words included in the ontology and arcs indicating relations between the plurality of nodes, and identifies the part to be extracted from the ontology by tracing the arcs between the nodes.

8. An apparatus according to claim 7, wherein the ontology editing section manages, for each of the nodes, internode distance information indicating the number of arcs between the nodes, and identifies the part to be extracted from the ontology by referencing the internode distance information.

9. An apparatus according to claim 1, wherein the ontology editing section identifies the part to be extracted from the ontology without dividing a set of words to be treated as a single group on the basis of a grammar of the ontology description language.

10. A computer system comprising a server storing an ontology and a client referencing the ontology by accessing the server,
wherein the client has an agent for transmitting a request specifying an inquiry word and an ontology extraction condition to the server; and
wherein the server includes:
an ontology storing section for storing data of the ontology described in an ontology description language; and
an ontology editing section for reading the ontology from the ontology storing section, extracting a part satisfying the word and the extraction condition specified in the request from the ontology, and transmitting it to the client.

11. A computer system according to claim 10, wherein the ontology editing section of the server converts the ontology described in the ontology description language into an N-triples notation, and identifies the part of the ontology satisfying the extraction condition by tracing relations of other words included in the ontology from the word specified in the request.

12. A computer system according to claim 10, wherein the ontology editing section of the server converts the ontology described in the ontology description language to an RDF model composed of nodes corresponding to the words and arcs indicating relations between the words, and identifies the part of the ontology satisfying the extraction condition by tracing the arcs between the nodes from a node corresponding to the word specified in the request.

13. A computer system according to claim 10, wherein the agent of the client adds a parameter for specifying a given word and the ontology extraction condition to a URL of a file of the ontology, and transmits an HTTP request including the URL with the parameter being described therein to the server.

14. A data processing method of a server transmitting an ontology to a client in response to a request from the client, comprising:
reading data of the ontology described in an ontology description language from a storage device and exploring relations between a plurality of words defined in the ontology;
acquiring a target word and an ontology extraction condition from the request from the client, and extracting a part satisfying the target word and the extraction condition from the ontology on the basis of relations between the plurality of words defined in the ontology; and
transmitting the extracted part of the ontology to the client.

15. A method according to claim 14, wherein words defined in the ontology are represented by nodes, and the extraction condition is specified by a node corresponding to the target word and the number of layers from the node.

16. A method according to claim 15, wherein if a plurality of target words are specified, the extraction condition is specified by the number of layers from nodes on a shortest path between the plurality of nodes.

17. A method according to claim 14, wherein words defined in the ontology are represented by nodes, and the extraction condition is specified by a node corresponding to the target word and the number of extracted nodes.

18. A method according to claim 14, wherein the server explores relations between a plurality of words by converting the ontology into an N-triples notation or to an RDF model having a plurality of nodes corresponding to the plurality of words defined in the ontology and arcs indicating relations between the words; the server extracts a part satisfying the target word and the extraction condition from the ontology in the N-triples notation or from the RDF model; and the server converts the extracted part of the ontology in the N-triples notation or of the RDF model to an ontology described in the ontology description language and transmits it to the client.

19. A method according to claim 14, wherein the part extracted from the ontology is identified without dividing a set of words to be treated as a single group, on the basis of a grammar of the ontology description language.
